(19) United States
(12) Patent Application Publication
(10) Pub. No.: US 2025/0326290 A1
(43) Pub. Date: Oct. 23, 2025

(54) CASSETTE FOR A DEVICE FOR CONTROLLING THE CIRCULATION OF AN AIR FLOW OF A MOTOR VEHICLE AND SHUTTER FOR SUCH A CASSETTE

(71) Applicant: RENAULT s.a.s, Boulogne Billancourt (FR)

(72) Inventors: Xavier DIMEY, Guyancourt (FR); Serghei SOLTOIAN, Guyancourt (FR); Katia VIEILLE, Guyancourt (FR)

(73) Assignee: RENAULT s.a.s, Boulogne Billancourt (FR)

(21) Appl. No.: 18/867,658

(22) PCT Filed: May 9, 2023
(86) PCT No.: PCT/EP2023/062244

§ 371 Date: Nov. 20, 2024

(30) Foreign Application Priority Data
May 24, 2022 (FR) FR2204988

(51) Int. Cl. B60K 11/08

(52) U.S. Cl. CPC B60K 11/085; B60Y 2410/113

(57) ABSTRACT

A cassette is for a device that controls the circulation of an air flow of a vehicle. The cassette includes a frame and a plurality of mobile shutters arranged on the frame. At least two adjacent shutters are arranged one after the other along a first axis to reversibly and rigidly co-operate with one another, such that a movement exerted on either of the two shutters is transmitted to the other of the shutters.

The invention relates to a cassette comprising shutters, notably movable shutters, for a device for controlling the circulation of an air flow of a vehicle, for example arranged at a grille or an air vent of a motor vehicle, and to said device. The invention also relates to an installation for circulating and/or heat treating an air flow, for example an installation for cooling a heat-transfer fluid or a heating, ventilation and air-conditioning installation, comprising such a device. Finally, the invention relates to a motor vehicle equipped with an installation and/or a device and/or a cassette according to the invention.

Motor vehicles comprise a grille mounted on a front end of the vehicle to circulate an external air flow toward at least one cooling module for at least one fluid notably intended to circulate through a heating device, such as a radiator of a heating, ventilation and air-conditioning (HVAC) installation. Such a cooling module usually comprises an assembly of heat exchangers traversed by ambient air to cool at least one fluid, notably a heat-transfer fluid intended to cool a combustion engine or a refrigerant fluid intended for the HVAC installation.

It is known to provide, in the air intake path, a device for controlling the circulation of the air flow comprising a cassette containing a plurality of movable shutters arranged in rows on a frame and controlled to selectively block and/or control the air flow upstream of the cooling module. One drawback of such controlled shutter cassettes is that they require at least two different types of shutter, having different dimensions, or even more if the device and/or the frame have a more complex architecture involving a variation in size, particularly in length, from one shutter row to another. Notably, such cassettes comprise a longer drive shutter coupled to an actuator shaft, and shutters driven in rotation by a connecting rod in mechanical relationship with said drive shutter, the drive shutter and the driven shutters. This means that it is necessary to increase the number of shutter types from one model of cassette, or device for controlling the circulation of an air flow, to another, combined with significant costs both to develop and to manufacture such parts.

The present invention falls within this context and aims to solve the aforementioned drawbacks by proposing a cassette equipped with shutters allowing a modular assembly, notably in length and/or in a direction of extension of said shutters, that is simple to assemble and that can be made at low cost to suit a wide variety of cooling modules.

The invention relates to a cassette for a device for controlling the circulation of an air flow of a vehicle, the cassette comprising a frame and a plurality of movable shutters arranged on said frame, at least two adjacent shutters being attached to each other and arranged one after the other along a first axis. Each of said two shutters comprises a body having, along the first axis, a first end portion and a second end portion opposite each other and comprising respectively a first coupling member and a second coupling member that are at least partially complementary in shape, said end portions being configured so that the bodies of the two adjacent shutters are connected to each other integrally and reversibly at least by coupling the first coupling member of one of the two adjacent shutters to the second coupling member of the other of said shutters in a coupling zone such that a movement, notably a rotation about the first axis, exerted on either one of said two shutters is transmitted to the other of said shutters.

Notably, the first coupling member and the second coupling member of at least one of the two adjacent shutters may be centered on the first axis.

Notably, within the two adjacent shutters, either the first coupling member or the second coupling member may have a cylindrical shape comprising at least one stop means and the other of the first coupling member and the second coupling member may have a hollow cylindrical shape able to receive either the first coupling member or the second coupling member, an inner surface of said hollow cylindrical shape comprising a stop element, complementary to the stop means, configured to connect the two adjacent shutters together integrally such that a movement, notably a rotation about the first axis, exerted on either one of said two shutters is transmitted to the other of said shutters.

The frame may further comprise at least one arm configured to cooperate with the first coupling member and/or with the second coupling member within the coupling zone connecting the two adjacent shutters. Notably, at least one of the first coupling member and/or the second coupling member within the coupling zone may comprise a flange configured to butt against the at least one arm in at least one or the other of the directions defined by the first axis.

The first end portion of each of the two adjacent shutters may further comprise at least one first member for transmitting a movement and the second end portion of each of the two adjacent shutters may further comprise at least one second member for transmitting a movement, at least the first transmission member of one of the two adjacent shutters being configured to cooperate with the second transmission member of the other of said two shutters in the coupling zone.

The invention also relates to a device for controlling the circulation of an air flow of a vehicle comprising a cassette as set out above and at least one means for adjusting the intake of the air flow configured to move, notably by rotation about the first axis, at least one of the two adjacent shutters.

The invention also relates to a shutter for a cassette or for a device for controlling the circulation of an air flow of a vehicle according to the invention. Such a shutter comprises a body extending along a first axis and having, along said axis, a first end portion and a second end portion that are opposite each other, the first end portion comprising a first coupling member configured to connect the body to an adjacent shutter arranged along the first axis integrally and reversibly, the second end portion comprising a second coupling member, at least partially complementary in shape to the first coupling member, configured to cooperate with a first coupling member of an adjacent shutter arranged along the first axis, the first coupling member and/or the second coupling member notably being centered on the first axis.

Notably, the first end portion may further comprise at least one first member for transmitting a movement and the second end portion may further comprise at least one second transmission member, the first transmission member being configured to cooperate with a second transmission member of an adjacent shutter arranged along the first axis and the second transmission member being configured to cooperate with a first transmission member of an adjacent shutter arranged along the first axis, the first transmission member and the second transmission member being centered on a second axis, distinct from the first axis.

The invention also relates to an installation for circulating and/or heat treating an air flow comprising a device for controlling the circulation of an air flow and/or at least one cassette and/or at least one shutter, all as set out above.

Notably, such an installation may comprise several rows of shutters, notably several horizontal rows of shutters, and the geometry of at least one shutter of a row of shutters may be different to the geometry of at least one other shutter of the row or of at least one shutter of an adjacent row.

Finally, the invention relates to a motor vehicle comprising a device for controlling the circulation of an air flow and/or an installation according to the invention.

Further details, features and advantages will become more clearly apparent from reading the detailed description given below by way of non-limiting indication, in relation to the various embodiment examples illustrated in the following figures:

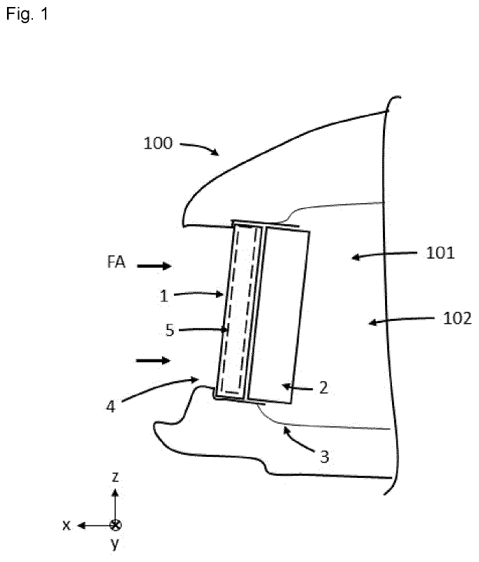

FIG. 1 is a schematic representation of a front face of a vehicle according to an embodiment comprising an installation and a control device according to the invention.

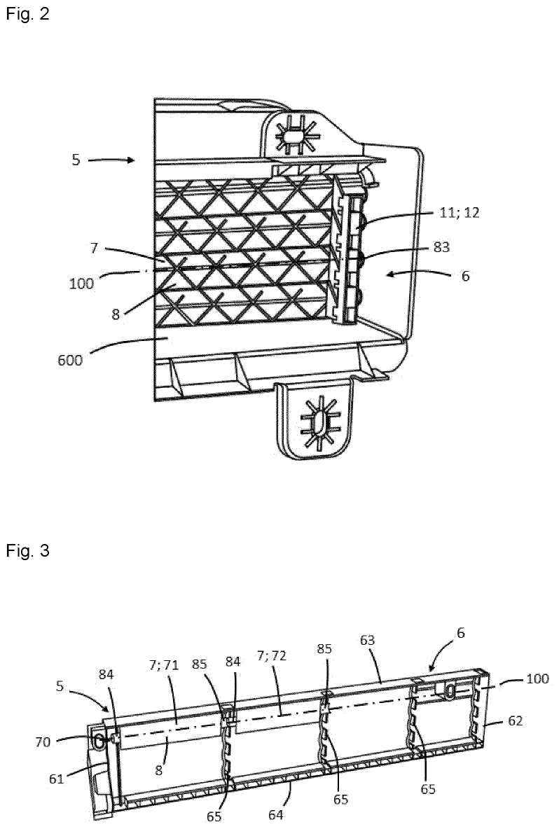

FIG. 2 is a simplified view of the control device comprising a cassette.

FIG. 3 is a schematic perspective view of a cassette comprising a plurality of shutters according to the invention.

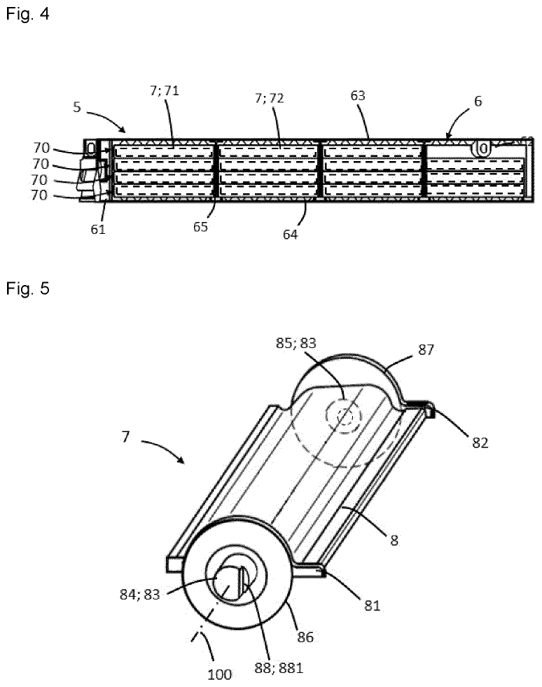

FIG. 4 is a schematic front view of the cassette comprising a plurality of shutters according to the invention.

FIG. 5 is a schematic view of an example embodiment of a shutter according to a first embodiment.

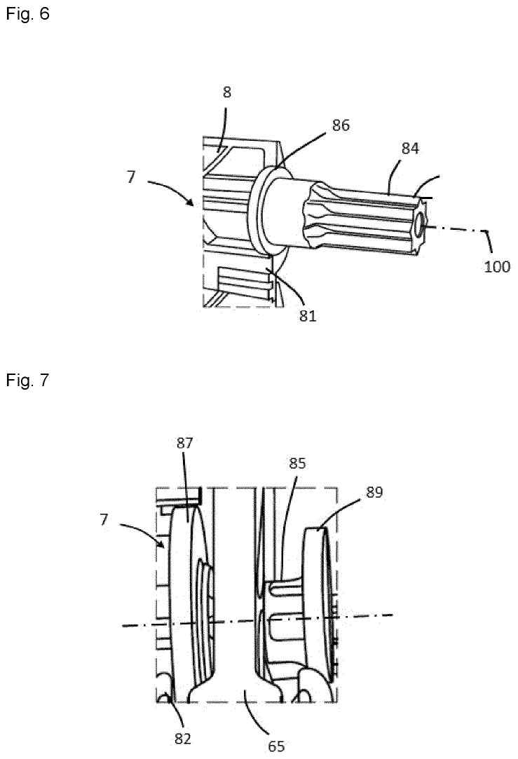

FIG. 6 is a schematic representation of an example coupling member of a shutter.

FIG. 7 is a schematic representation of an example coupling member of a shutter.

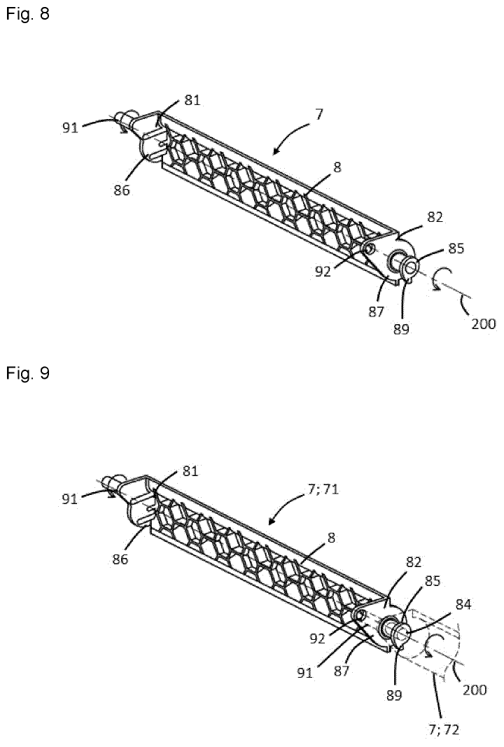

FIG. 8 is a schematic representation of an example embodiment of a shutter according to a second embodiment.

FIG. 9 is a schematic representation of the shutter according to the second embodiment cooperating with an adjacent shutter.

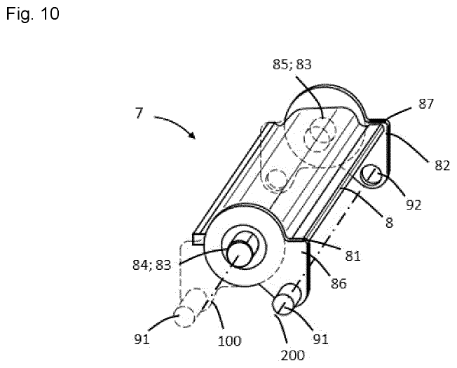

FIG. 10 is a schematic representation of example embodiments of the shutter according to the second embodiment.

FIG. 1 schematically illustrates an example embodiment of a vehicle 100, notably a motor vehicle equipped with a cooling module 101, which may be integrated in full or in part into a heating, ventilation and air-conditioning (HVAC) installation, and/or a cooling system of the engine. The cooling module 101 notably comprises at least one heat exchanger 2 configured to execute a heat exchange with an external air flow FA passing therethrough according to the requirements established according to the operating phase of the vehicle. Throughout the description below, the cooling module 101 is described as comprising a single heat exchanger 2. It is nevertheless understood that the present invention also applies to a cooling module comprising a plurality of heat exchangers 2.

The installation 102 comprises a device 1 for controlling the circulation of the external air flow FA, notably electrically controlled, and at least the heat exchanger 2 can be configured to cool or heat said air flow FA. The installation 102 further comprises a housing 3 forming a distribution circuit for the external air flow FA in which the control device 1 and the heat exchanger 2 are arranged. The housing 3 opens onto a grille 4 of the vehicle 100, notably on the front face of the vehicle 100, through which the installation is supplied with the external air flow FA, the control device 1 being for example arranged upstream of the heat exchanger 2 in the direction of circulation of the external air flow FA.

FIGS. 2 to 10 illustrate various examples and embodiments of the control device 1 according to the invention in greater detail. With reference to the orientations and directions defined above, the longitudinal direction is represented by the axis Ox and corresponds to a direction of travel of the vehicle, while the axes Oy and Oz represent the vertical and transverse directions respectively. These axes together define a reference system Oxyz shown in the relevant figures. Furthermore, the direction of circulation of the external air flow is represented schematically by arrows. Finally, it is understood that the terms “first” and “second” are intended to distinguish similar elements and not to define a hierarchy for said elements.

In general, the control device 1 includes a cassette 5 which comprises a frame 6 and a plurality of shutters 7 arranged on said frame 6 so as to be movable relative thereto, i.e. so as to be movable between at least two different positions, as further set out below. Likewise, such shutters 7 are attached and removable relative to the frame 6. In addition, the device comprises a means 11 for adjusting the intake of the air flow FA configured to move some or all of the shutters 7 of the cassette 5 so as to control said flow. The adjustment means 11 notably comprises at least one means 12 for driving at least one shutter of the plurality of movable shutters 7, which may notably be actuated by electric control.

According to a non-limiting example embodiment, the frame 6 may comprise at least a first flank 61, a second flank 62, a third flank 63, and a fourth flank 64. The first flank 61 and the second flank 62 are opposite each other and are connected together by the third flank 63 and the fourth flank 64. In the example illustrated, the frame 6, and notably the flanks 61, 62, 63, 64 of the frame 6, can therefore have, in a non-limiting manner, a substantially parallelepipedal continuous shape defining an internal volume 600 of the control device in which the plurality of shutters 7 are arranged. In particular, at least two opposing flanks of the frame 6 may be configured to carry the adjustment means 11. In this case, these are the first flank 61 and the second flank 62.

Optionally, as illustrated in FIGS. 3 and 4, the frame 6 can further comprise at least one or more support arms 65 configured to cooperate with at least one shutter 7 of the plurality of shutters 7. Preferably, the frame 6 may comprise a plurality of support arms 65 distributed in the internal volume 600. The arms extend between two opposing flanks, in this case between the third flank 63 and the fourth flank 64.

The cassette 5 comprises a plurality of movable shutters 7. In particular, according to the invention, the cassette 5 comprises at least two adjacent shutters 71, 72 arranged one after the other along a first axis 100 and configured to cooperate with each other reversibly and integrally such that a movement exerted on either one of said two shutters 71, 72 is transmitted to the other of said shutters. Notably, one considered movement is a rotational movement about the first axis 100. Said shutters are attached and removable relative to each other, so that their connection is reversible. “Adjacent” shutters 7 is therefore understood to mean shutters 7 arranged side by side, notably in direct cooperation with each other, along the first axis 100. The term “integral” is understood to mean that, when one of said two shutters 7 is controlled to move, in this case in a rotational movement, the other of said shutters is driven, for example so as to perform an identical movement in a synchronized manner. In other words, the shutters 7 connected integrally to each other in the direction defined by the first axis 100 are moved concomitantly relative to the frame 6 but are immobile relative to each other. Such a connection, as set out further below, is reversible in the context of assembly or disassembly of the cassette 5. Such a principle provides a modular cassette 5 in which a plurality of shutters 7 can be stacked along the first axis 100 as required, for example so as to fit a dimension of the frame 6 defined along this same axis, in this case notably a length between the first flank 61 and the second flank 62, which are opposite each other. The present invention thus advantageously makes it possible to increase the number of shutters stacked in the direction defined by the first axis as required, without having to develop new shutter types.

In addition, optionally, the cassette 5 may comprise one or more rows 70 each comprising one or more shutters 7. For example, such rows 70 may extend in a direction parallel to the first axis 100 and may be arranged side by side in a direction transverse to the first axis 100, notably orthogonal thereto. For example, a given row may comprise a single shutter as conventionally known in the prior art or, alternatively, at least two adjacent shutters 7 arranged one after the other along an axis parallel to the first axis 100 according to the invention.

For the sake of clarity, the following description is provided with reference to two particular adjacent shutters 7 of the plurality of shutters. It is nevertheless understood that the entire description applies, mutatis mutandis to some or all of the shutters 7 of the plurality of shutters 7 of the cassette 5. Furthermore, the present invention also relates to a shutter configured to be used in a cassette 5 according to the invention, i.e. a shutter configured to be stacked with one or more separate shutters 7 along the first axis 100. Furthermore, the whole of the description below applies to such a shutter.

As illustrated schematically in FIGS. 3 and 5, the two adjacent shutters 7 have an elongate structure. They each comprise a body 8 having, along the first axis 100, a first end portion 81 and a second end portion 82 opposite each other. The body 8 of the shutters 7 may comprise one or more vanes mounted on pivots 83 centered on the first axis 100. For example, at least one of the pivots 83 may be mounted on one of the flanks of the frame 6 and/or on one of the arms 65 and/or on a separate shutter, as set out below. The arms 65 can then extend transversely, or even orthogonally, to the first axis 100 and carry the pivot 83 of at least one of the two adjacent shutters 7. The body 8 may have a flat or substantially flat shape. Alternatively, the body 8 may have a substantially curved shape.

At least the two adjacent shutters 7 are thus mounted movably, notably pivotingly, for example about the first axis 100, relative to the frame 6 to be moved between a first position and a second position. The drive means 12 is able to engage some or all of the plurality of shutters 7 by driving, in order to move them selectively between the first position and the second position. By way of non-limiting example, the drive means 12 may comprise a drive shaft and/or an actuator, such as a motor or any other electromechanical device (not shown).

In the first position, the shutters 7 restrict the passage of the external air flow through the frame 6, for example through the grille of the vehicle, whereas, in the second position, said shutters 7 allow the air flow FA to circulate through the frame 6, and therefore the grille of the vehicle, i.e. toward the heat exchanger 2. In other words, when the shutters 7 are moved into the first position, the control device 1 is in a “closed” configuration preventing the air flow FA from entering the installation. Conversely, when the shutters 7 are moved into the second position, the control device 1 is in an “open” configuration allowing the air flow FA to circulate within the installation 102, notably through the control device 1 and the heat exchanger 2. It is understood that, optionally, the control device 1 can also be configured to implement one or more “intermediate” configurations to ensure the circulation of a reduced external air flow FA compared to the open configuration, notably depending on the requirements of the installation or of the vehicle. In such configurations, at least some of the shutters 7 of the plurality of shutters 7 can be moved into an intermediate position between the first position and the second position.

As set out above, at least the two adjacent shutters 71, 72 are configured to cooperate with each other such that a movement exerted on either one of said two shutters is transmitted to the other of said shutters. To this end, the first end portion 81 and the second end portion 82 of the shutter may be made according to different embodiments.

According to a first embodiment, illustrated in FIGS. 4 to 7, the first end portion 81 comprises a first coupling member 84 and the second end portion 82 comprises a second coupling member 85 at least partially complementary in shape to the first coupling member 84. The coupling members within a given shutter, as well as the members coupling one of the two shutters to the other, are complementary in shape, so that said two shutters can be connected to each other without any constraint in terms of order. The first coupling member 84 and the second coupling member 85 are particularly configured so as to enable the bodies 8 of the two adjacent shutters 7 to be connected to each other by reversibly coupling the first coupling member 84 of one of the two adjacent shutters 7 with the second coupling member 85 of the other of said shutters 7 in a coupling zone. The term “coupling zone” is understood to mean a reversible connection zone between a first coupling member 84 of a shutter according to the invention and a second coupling member 85 of a separate shutter, adjacent to said shutter in the direction defined by the first axis 100. For example, within the cassette 5, some or all of the shutters 7 of the plurality of shutters 7 may comprise at least one coupling zone, notably one coupling zone or two coupling zones depending on whether the considered shutter cooperates with one or more shutters 7 according to the invention. In other words, each shutter according to the invention can be reversibly connected to two separate shutters according to the invention via the first coupling member 84 on the one hand and the second coupling member 85 on the other hand, so as to form a stack along the first axis 100.

The first coupling member 84 and the second coupling member 85 of at least one of the two adjacent shutters 7 are traversed by the first axis 100. Notably, they are centered on the first axis 100. The first coupling member 84 and the second coupling member 85 can then coincide at least in part with the pivots 83 of the considered shutter. In particular, the first coupling member 84 and the second coupling member 85 of the two adjacent shutters 7 are centered on the first axis 100 when said shutters are assembled together, i.e. connected to each other in the coupling zone. The coupling members belonging to the two adjacent shutters 7 are then aligned along the first axis 100. The first coupling member 84 can be arranged in the first end portion 81 on a first plate 86 while the second coupling member 85 is arranged on a second plate 87. The first plate 86 and the second plate 87 are connected to the body 8 and delimit the body in the direction defined by the first axis 100.

The shutter according to the invention can be made so that the assembly formed by the first coupling member 84, the body 8, and the second coupling member 85 forms a one-piece part. In other words, the first coupling member 84, the body 8, and the second coupling member 85 form a one-piece assembly, in which the coupling members cannot be separated from the body 8 of the considered shutter without damaging or even destroying the latter. For example, the shutter can be made of reinforced plastic material(s), notably using any kind of fibers with a filler percentage of up to 50%.

The first coupling members 84 of at least the two adjacent shutters 71, 72 preferably have identical shapes and/or dimensions. Also, the second coupling members 85 of at least the two adjacent shutters preferably have identical shapes and/or dimensions so that said shutters can be connected to each other without any particular constraint in terms of order.

The first coupling member 84 may have a cylindrical shape comprising at least one stop means 88. The second coupling member 85 may have a hollow cylindrical shape able to receive the first coupling member 84. An inner surface of said hollow cylindrical shape comprises a stop element complementary to the stop means 88 (not shown). The stop means 88 and the stop element are advantageously configured to connect the two adjacent shutters 7 together integrally such that a movement, notably a rotation about the first axis 100, exerted on either one of said two shutters 7 is transmitted to the other of said shutters 7. In this sense, the stop element hinders the movement of the stop means 88 and vice versa along a trajectory effected by the shutter when the shutter is moved. If one of the shutters 71, 72 is moved, either the stop element or the stop means exerts a force on the other so as to drive the other of the shutters 71, 72. In this way, the shutters 71, 72 are not moved relative to each other. It is understood that the shape of the first coupling member 84 and of the second coupling member 85 can be inverted.

According to an example embodiment illustrated in FIG. 6, the first coupling member 84 may have a cruciform profile, a star profile, or a profile of any other similar shape, the stop means 88 being formed by at least one branch of said profile. In this case, the term “profile” is understood to mean the shape of the member in a plane orthogonal to the first axis 100. For example, said profile may be centered on the first axis 100. The inner surface of the hollow cylindrical shape of the second coupling member 85 may be inscribed in a profile of a shape that is at least partially complementary to the profile of the first coupling member 84, said inner surface comprising the stop element complementary to the stop means 88, for example in this case one of the branches.

Alternatively or in combination, the stop means 88 may be a flat 881 on the first coupling member 84, as shown in FIG. 5. The inner surface of the hollow cylindrical shape of the second coupling member 85 may then be inscribed in a profile of a shape that is at least partially complementary to the profile of the first stop member, notably complementary to the part of the stop means 88 formed by the flat 881.

Advantageously, as illustrated in FIG. 7, the at least one arm 65, or one of the arms 65, of the frame 6 can be configured to cooperate with the at least one coupling zone connecting the two adjacent shutters 7. Notably, the at least one arm 65 is configured to cooperate with the first coupling member 84 and/or with the second coupling member 85 within the coupling zone connecting the two adjacent shutters 7. For example, the arm 65 may comprise a recess or an opening configured to receive the first coupling member 84 and/or the second coupling member. When the considered shutter comprises two coupling zones, as set out above, the cassette 5 can be configured so that a plurality of arms 65 of the body 8 cooperate with a given shutter, each in a separate coupling zone.

Optionally, in order to limit or even prevent a movement of at least one of the two adjacent shutters 7 along the first axis 100, at least one of the first coupling member 84 and/or of the second coupling member 85 within the coupling zone comprises a flange 89. The flange 89 is configured to butt against the at least one arm 65 in at least one or the other of the directions defined by the first axis 100. The flange 89 extends transversely, for example orthogonally, to the first axis 100. For example, the flange 89 may be included in the second coupling member 85, notably at a free end thereof. According to a non-limiting example embodiment, the flange 89 may have the shape of a ring bordering all or part of a contour of an outer surface of the hollow shape of the second coupling member 85 able to receive a first coupling member 84. Alternatively, the flange 89 may be in the form of a projection extending radially relative to an axis on which the second coupling member is centered and arranged on only part of the contour of the outer surface of the hollow shape of the second coupling member 85.

Alternatively or in combination, such a flange 89 may be included in the first coupling member 84, for example at a base of the cylindrical shape, in the vicinity of the first plate 86 and at a non-zero distance from a free end of the first coupling member 84. In addition, the arms 65 can then ensure, by means of the flange 89, the positioning of each shutter 7 in the direction defined by the first axis 100 in order to maintain the minimum interconnection necessary for the transmission of the rotational drive, since the arms 65 are subjected to forces due to the air pressure, mainly when the shutters 7 are moved into the first position, i.e. the control device 1 is in the “closed” configuration preventing the air flow FA from entering the installation.

Thus, in the cassette 5 according to the invention, when a movement, notably a rotational movement, is exerted on one of the two connected adjacent shutters 71, 72, said movement is transmitted to the other of said shutters 71, 72 via their own coupling members 84, 85 within the coupling zone. For example, in the example illustrated in FIG. 3 or 4, a first shutter 71 is driven by the drive means 12 and is connected to a second shutter 72. A rotational movement about the first axis 100 can be imposed on the first shutter 71 by the drive means 12, for example at one of the pivots and/or the first coupling member 84. The first shutter 71 pivots about the first axis 100 and the body 8 tilts so as to be moved between the first position and the second position. The first coupling member 84 and the second coupling member 85 of the first shutter 71 pivot together. In the coupling zone, the second coupling member 85 of the first shutter, which has a hollow cylindrical shape, cooperates, and in particular receives, the first coupling member 84 of the second shutter. The stop element in the inner surface of said hollow shape is in contact with the stop means 88 in the first coupling member 84 of the second shutter 72. When the first shutter 71 is moved, the second shutter 72 is driven, the second coupling member 85 of the first shutter 71 and the first coupling member 84 of the second shutter 72 thus being configured so that said shutters 7 remain immobile relative to each other. The second shutter 72 is thus driven in motion by the first shutter 71, so as to perform an identical movement. The two shutters 7 thus form a subassembly of the plurality of shutters 7 included in a given row that can be moved as one. Such a principle also applies when more than two shutters are stacked along the first axis 100.

Thus, within the cassette 5 according to the invention, at least two adjacent shutters 7 can be stacked in the direction defined by the first axis 100. Advantageously, more shutters 7 can be stacked in this same direction. In addition, such a principle can be repeated in one or more rows 70 of shutters 7 included in the cassette 5 and extending in a direction orthogonal to the first axis 100. In other words, the cassette 5 may comprise a plurality of sub-assemblies of adjacent shutters 7, each subassembly comprising at least two shutters 7 connected to each other by a coupling zone as set out above and stacked along an axis specific to it so as to form a row distinct from the rows of the other subassemblies. Notably, some or all of the axes specific to the different rows, including the first axis 100, may extend parallel to each other. The cassette 5 and the shutters 7 according to the invention thus enhance the modularity of the devices for controlling an air flow, the number of shutters 7 stacked within a row being simply adaptable, as required, by adding or removing a shutter. In this sense, shutters 7 of a given row, i.e. those stacked along a given axis, may have identical or different lengths corresponding to one dimension of the shutter along said axis. Furthermore, the cassette 5 may comprise an identical or different number of shutters 7 stacked from one row to another. Alternatively or additionally, the cassette 5 may be configured to comprise rows of variable or identical dimensions in the direction defined by the first axis 100. For example, the frame 6 may be shaped and/or dimensioned to receive a predetermined number of shutters 7 according to the invention. FIG. 3 illustrates a non-limiting example embodiment in which a top row is intended to receive one shutter 7 fewer than the other rows so that a zone without a shutter is in this case used as a zone for fastening the frame 6 to a support part. According to an alternative, a zone with no shutters may be intended for another requirement, such as a permanent air flow, functional interface, or permanent obstruction, depending on the cooling requirements, notably the cooling requirements of a heat exchanger exposed to a cooling air flow.

Optionally, the dimension of a row can be adapted by simply adjusting the geometry and/or dimension of at least one shutter 7, for example by modifying the dimension of the body 8 of the shutters. Advantageously, the coupling members remain identical to that set out above, thereby obviating the need to develop entirely new types, which tends to reduce the design diversity.

FIGS. 8 to 10 illustrate an example embodiment of a second embodiment of a shutter according to the invention. The second embodiment is similar to the embodiment set out above, and the description above applies mutatis mutandis, in particular with respect to the coupling members. The second embodiment differs from the first embodiment in that the first end portion 81 of each of the two adjacent shutters 7 further comprises at least one first member 91 for transmitting a movement and the second end portion 82 of each of the two adjacent shutters 7 further comprises at least one second member 92 for transmitting a movement. The first transmission member 91 and the second transmission member 92 are notably complementary in shape so that the first member of one of the two adjacent shutters 7 is configured to cooperate with the second transmission member 92 of the other of said two shutters 7 without constraint in terms of assembly order.

It should be noted that the first coupling member 84 and the second coupling member 85 may have profiles as defined above, comprising the stop means 88 and the stop element respectively. The first transmission member 91 and the second transmission member 92 then participate in ensuring the transmission from one of the coupled shutters 7 to the other in combination with the first coupling member 84 and the second coupling member 85, the transmission members 91, 92 facilitating such a movement.

Alternatively, the first coupling member 84 may have a simple cylindrical shape, with no stop means 88, and the second coupling member 85 may have a complementary hollow cylindrical shape, configured to receive the first coupling member 84. The first transmission member 91 and the second transmission member 92 then perform the transmission function in full of one of the shutters 7 coupled to the other.

Notably, the first transmission member 91 and the second transmission member 92 of a considered shutter are traversed by a second axis 200, distinct from the first axis 100. In particular, the first transmission member 91 and the second transmission member 92 of a considered shutter are centered on the second axis 200. According to an example embodiment, the second axis 200 extends parallel to, or substantially parallel to, the first axis 100. In other words, the second axis 200 is offset in position from the first axis 100 and/or an axis defined by the pivot. Notably, the second axis 200 can be offset in position from the at least one arm 65.

The first transmission member 91 may comprise a stud, for example a cylindrical stud. Similarly to the first transmission member, the first transmission member 91 may be carried by the first plate 86. Notably, the first transmission members 91 of at least the two adjacent shutters 7 have an identical shape and/or identical dimensions. Notably, the second transmission members 92 of at least the two adjacent shutters 7 have an identical shape and/or identical dimensions.

The second transmission member 92 may comprise an orifice or, according to an alternative (not shown), a cavity configured to cooperate with the first transmission member 91. Optionally, the second transmission member 92 may be carried by the second plate 87. It should be noted that the shapes of the first transmission member 91 and of the second transmission member 92 may be inverted.

Advantageously, the shutters 7 can be shaped so that, when the cassette 5 is installed in the control device or the installation for circulating and/or heat treating an air flow, the first axis 100 may be interposed between the first transmission member 91 and the second transmission member 92 on the one hand, and the heat exchanger 2 on the other hand in a direction of circulation of the air flow. In other words, the first axis 100 is interposed between the second axis 200 and said heat exchanger.

Alternatively, as shown in dotted lines in FIG. 10, the shutters 7 may be shaped so that, when the cassette 5 is installed in the control device or the installation for circulating and/or heat treating an air flow, the first transmission member 91 and the second transmission member 92 are interposed between the first axis 100 and the heat exchanger 2 in the direction of circulation of the air flow. In other words, the second axis 200 is interposed between the first axis 100 and said heat exchanger.

In this way, at least the two adjacent shutters 7 can be selected to suit characteristics and/or dimensions specific to the control device 1 and/or to the frame 6. For example, the positioning of the first transmission member 91 and of the second transmission member 92 may be defined according to the shape and/or the position of the arm or arms 65 in the frame 6. Also, the positioning of the first transmission member 91 and of the second transmission member 92 can be defined depending on whether or not there are means for blocking particles and/or projections through the frame 6, such as bars or fins of “stone guard” gratings fitted in the vicinity of the cassette 5.

The principle of transmission of a movement from one to the other of the at least two shutters 71, 72 as described recently applies mutatis mutandis. In this case, when two adjacent shutters 71, 72 are stacked in the direction defined by the first axis 100, as above, in the coupling zone, the coupling members 85, 86 and/or the transmission members 91, 92 connecting the first shutter 71 to the second shutter 72 ensure that said shutters remain integral with each other and immobile relative to each other. As above, the second coupling member 85 of the first shutter 71, which has a hollow cylindrical shape, cooperates with, and in particular receives, the first coupling member 84 of the second shutter 72. Also, the second transmission member 92 of the first shutter, in this case an orifice included in the second plate 87, receives the first transmission member 91, and they are configured so as to limit, or even prevent, the movement of the first shutter 71 relative to the second shutter 72 in at least one direction orthogonal to the first axis 100. Optionally, the coupling members of the coupling zone, the stop element, and the stop means can perform a similar function. When the first shutter 71 is moved, the second shutter 72 is driven in motion by the first shutter so as to perform an identical movement. Such a principle also applies when more than two shutters 7 are stacked along the first axis 100.

Thus, the present invention proposes a cassette comprising a plurality of shutters for a device for controlling the circulation of an air flow, for example intended for a vehicle. Such a cassette comprises removable shutters advantageously configured to be stacked reversibly in a direction so as to form one or more rows of modular dimensions within which the shutters move integrally at least within one considered row. The invention advantageously enables, with a low-cost solution that is simple to implement, the integration of the shutters according to the invention with cassettes of variable models and dimensions.

The present invention, however, is not limited to the means and configurations described and illustrated here and it also applies to any equivalent means or configuration and to any technically feasible combination of such means insofar as they perform the functionalities described and illustrated in the present document in fine.

1-12. (canceled)

13. A cassette for a device for controlling circulation of an air flow of a vehicle, the cassette comprising:
a frame and a plurality of movable shutters arranged on said frame, at least two adjacent shutters being attached to each other and arranged one after the other along a first axis, each of said two shutters comprising a body having, along the first axis, a first end portion and a second end portion opposite each other and comprising respectively a first coupling member and a second coupling member that are at least partially complementary in shape, said end portions being configured so that the bodies of the two adjacent shutters are connected to each other integrally and reversibly at least by coupling the first coupling member of one of the two adjacent shutters to the second coupling member of the other of said shutters in a coupling zone such that a movement exerted on either one of said two shutters is transmitted to the other of said shutters.

14. The cassette as claimed in claim 13, wherein the movement is a rotation about the first axis.

15. The cassette as claimed in claim 13, wherein the first coupling member and the second coupling member of at least one of the two adjacent shutters are centered on the first axis.

16. The cassette as claimed in claim 13, wherein, within the two adjacent shutters, either the first coupling member or the second coupling member has a cylindrical shape comprising at least one stop means and the other of the first coupling member and the second coupling member has a hollow cylindrical shape configured to receive either the first coupling member or the second coupling member, an inner surface of said hollow cylindrical shape comprising a stop element, complementary to the stop means, configured to connect the two adjacent shutters together integrally such that the movement exerted on either one of said two shutters is transmitted to the other of said shutters.

17. The cassette as claimed in claim 13, wherein the frame further comprises at least one arm configured to cooperate with the first coupling member and/or with the second coupling member within the coupling zone connecting the two adjacent shutters.

18. The cassette as claimed in claim 17, wherein at least one of the first coupling member and/or the second coupling member within the coupling zone comprises a flange configured to butt against the at least one arm in at least one or the other of the directions defined by the first axis.

19. The cassette as claimed in claim 13, wherein the first end portion of each of the two adjacent shutters further comprises at least one first member for transmitting a movement and the second end portion of each of the two adjacent shutters further comprises at least one second member for transmitting a movement, at least the first transmission member of one of the two adjacent shutters being configured to cooperate with the second transmission member of the other of said two shutters in the coupling zone.

20. A device for controlling the circulation of an air flow of a vehicle comprising:
the cassette as claimed in claim 13; and
at least one means for adjusting an intake of the air flow configured to move at least one of the two adjacent shutters.

21. The device as claimed in claim 20, wherein the at least one means for adjusting an intake of the air flow is configured to move by rotation about the first axis.

22. A shutter for the cassette as claimed in claim 13, the shutter comprising:
a body extending along a first axis and having, along said axis, a first end portion and a second end portion that are opposite each other, the first end portion comprising a first coupling member configured to connect the body to an adjacent shutter arranged along the first axis integrally and reversibly, the second end portion comprising a second coupling member, at least partially complementary in shape to the first coupling member, configured to cooperate with a first coupling member of an adjacent shutter arranged along the first axis.

23. The shutter as claimed in claim 22, wherein the first coupling member and/or the second coupling member is centered on the first axis.

24. The shutter as claimed in claim 22, wherein the first end portion further comprises at least one first member for transmitting a movement and the second end portion further comprises at least one second transmission member, the first transmission member being configured to cooperate with a second transmission member of an adjacent shutter arranged along the first axis and the second transmission member being configured to cooperate with a first transmission member of an adjacent shutter arranged along the first axis, the first transmission member and the second transmission member being centered on a second axis, distinct from the first axis.

25. An installation for circulating and/or heat treating an air flow, comprising at least one of the cassette as claimed in claim 13

26. The installation as claimed in claim 25, further comprising a plurality of rows of the shutters, wherein that the geometry of at least one shutter of a row of shutters is different than the geometry of at least one other shutter of the row or of at least one shutter of an adjacent row.

27. The installation as claimed in claim 26, wherein the plurality of rows of the shutters includes several horizontal rows of shutters.

28. A motor vehicle comprising:
the device for controlling the circulation of an air flow as claimed in claim 20.
